(19) United States
(12) Patent Application Publication
(10) Pub. No.: US 2013/0290043 A1
(43) Pub. Date: Oct. 31, 2013

(54) METHODS AND SYSTEMS FOR HANDLING TRANSPORTATION RESERVATION REQUESTS IN A DECENTRALIZED ENVIRONMENT

(71) Applicant: Board of Trustees of the University of Alabama, Tuscaloosa, AL (US)

(72) Inventors: Mohammad Asadul Hoque, Tuscaloosa, AL (US); Xiaoyan Hong, Tuscaloosa, AL (US); Brandon Dixon, Tuscaloosa, AL (US)

(21) Appl. No.: 13/832,091

(22) Filed: Mar. 15, 2013

Related U.S. Application Data
(60) Provisional application No. 61/637,947, filed on Apr. 25, 2012.

(51) Int. Cl. G06Q 10/02

(52) U.S. Cl. CPC G06Q 10/02
USPC 705/5

(57) ABSTRACT

Methods and systems for handling transportation reservation requests in a decentralized environment are discussed herein. An example decentralized system for handling transportation reservation requests may include a road-side device, a hailing device and/or a vehicle device. In the example decentralized system, the road-side device and/or the hailing device can be configured to communicate with the vehicle device using a vehicular communication channel. In some implementations, the vehicular communication channel can be reserved exclusively for vehicle-to-vehicle and vehicle-to-infrastructure communications.

### CROSS-REFERENCE TO RELATED APPLICATIONS

This application claims the benefit of U.S. Provisional Patent Application No. 61/637,947, filed on Apr. 25, 2012, entitled “Methods and Systems for Handling Transportation Reservation Requests in a Decentralized Environment,” the disclosure of which is expressly incorporated herein by reference in its entirety.

### BACKGROUND

Taxis play an invaluable role in urban transportation. According to the NYC Taxi cab fact book, on an average 470,000 trips are made by 13,000 yellow cabs per day in New York City, carrying nearly 241 million passengers annually. This numerical figure is even exceeded in some other major metropolitan cities across the globe. In Singapore city, the total number of taxis, by the end of 2010, was 26,073 making around 600,000 trips per day. These statistics indicate the invaluable role of taxis in urban life. In many cases, passengers prefer taxis over cheaper options such as public transit. However, finding a taxi sometimes can be cumbersome, mostly during the busy hours, or in unpopular places. In these cases, the passengers are often delayed by long periods of time when searching for a taxi.

One major reason for these troubled cases is the lack of an efficient communication method. Most passengers do not prefer to call the taxi company for off and on trips, and even if they do, many of the passengers may not even have the phone numbers handy. Accordingly, calling the taxi company over a phone to make reservations or to request pickup often gets cumbersome and creates passenger dissatisfaction, especially during rush hours. Another important fact is that some cities or areas may not have the service for prearrangement taxi by phone. For example, New York City does not allow calling a taxi over the phone within Manhattan, which is the pickup location for more than 70% trips of the entire New York City.

Therefore, there is a need for an efficient, user-friendly dispatching system. There are several automated dispatching systems utilized by the industry. The majority of these dispatching systems are centralized (i.e., require a central operator or central server). For example, in Singapore, a satellite-based centralized dispatch service known as Automatic Vehicle Location and Dispatch Systems (AVLDS) is utilized. AVLDS includes vehicles (i.e., taxis) having GPS receivers, a wireless communication link between the vehicles and a central server, and automated dispatching software. The wireless communication link is typically the cellular network. Passengers may reserve transportation (i.e., hail taxis) by telephone, SMS, Internet, fax, smart phone application, etc. AVLDS is discussed in detail in Liao, Z., Real-Time Taxi Dispatching Using Global Position Systems, Comm. of ACM—Wireless Networking Security, Vol. 46, Issue 5 (2003). However, centralized dispatching systems have several disadvantages. First, although booking a taxi using a phone is one of the most conventional means, at times of high demand, passengers may have difficulty calling the central dispatcher due to high call volume. In addition, it may be difficult to accurately convey the pickup location to the central dispatcher or central server. As a result, the taxi driver may be unable to locate the passenger or may pick up a different passenger, which results in passenger dissatisfaction. Additionally, the cost of maintaining a central dispatching system (i.e., a call center and/or server) to provide high-quality service 24 hours per day and 7 days per week can be expensive.

A decentralized dispatching system using a mobile adhoc network (MANET) has also been proposed in literature. The example decentralized dispatching system is discussed in detail in Zhou et al., EZCab: A Cab Booking Application Using Short-Range Wireless Communication, In Proceedings of Third International Conference on Pervasive Computing (2005). In the proposed EZCab system, the vehicles are the nodes of the MANET and perform the distributed computations required to reserve a taxi. For example, the vehicles may communicate with each other wirelessly using IEEE 802.11. In order to reserve a taxi, the passenger must join the MANET by communicating directly with vehicles within transmission range of the passenger. This communication can then be forwarded to available vehicles within the MANET. Although the proposed EZCab system is decentralized (i.e., does not require a central operator or central server, which reduces the infrastructure cost), it has several disadvantages. First, the passenger is required to use a computing device configured to communicate wirelessly (i.e., using IEEE 802.11) with the vehicles. For example, the passenger may be required to use a smart phone or PDA. In addition, it may be difficult to route the service request to available taxis using the MANET even when available taxis are in close proximity to the passenger. Additionally, the EZCab system requires installation of a dedicated application on the passenger's computing device.

### SUMMARY

Methods and systems for handling transportation reservation requests in a decentralized environment are discussed herein. An example decentralized system for handling transportation reservation requests may include a road-side device, a hailing device and/or a vehicle device. In the example decentralized system, the road-side device and/or the hailing device can be configured to communicate with the vehicle device using a vehicular communication channel. In some implementations, the vehicular communication channel can be reserved exclusively for vehicle-to-vehicle and vehicle-to-infrastructure communications.

According to one implementation, a method for reserving transportation may include: sending a service request over a vehicular communication channel to at least one vehicle, the service request comprising a pickup location; and receiving an acknowledgment to the service request over the vehicular communication channel from at least one vehicle. In some implementations, a range of the service request and the acknowledgment to the service request may be less than approximately 1 km. In addition, the vehicular communication channel may operate at approximately 5.9 GHz. For example, the vehicular communication channel may be a dedicated short range communication (DSRC) channel.

Optionally, the service request may be sent directly from a mobile computing device to the at least one vehicle, the acknowledgment to the service request may be received at the mobile computing device directly from the at least one vehicle, and the pickup location may be a location of the mobile computing device.

Alternatively, the service request may be sent through a road-side device to the at least one vehicle, the acknowledgment to the service request may be received through the road-side device from the at least one vehicle, and the pickup location may be a location of the road-side device.

The method may also include: receiving acknowledgments to the service request over the vehicular communication channel from a plurality of vehicles; selecting a vehicle among the plurality of vehicles that acknowledged the service request; sending a service offer to the selected vehicle over the vehicular communication channel; and receiving an acknowledgment to the service offer over the vehicular communication channel from the selected vehicle. In addition, the acknowledgment to the service offer may identify the selected vehicle and estimates a time of arrival at the pickup location.

In another implementation, the method may include sending a dispatch message over the vehicular communication channel to the plurality of vehicles. The dispatch message may indicate that the service request has been fulfilled.

According to another implementation, the method may include: sending the service request over the vehicular communication channel to the at least one vehicle using a first device; and after expiration of a predetermined period of time without receiving an acknowledgement to the service request, resending the service request over the vehicular communication channel to the at least one vehicle using the first device. The re-sent service request may include a relay request that is configured to cause at least a second device geographically separated from the first device to broadcast the re-sent service request.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating a de-centralized system for reserving transportation according to an implementation of the invention;

FIG. 2 is a block diagram illustrating an example communication device according to an implementation of the invention;

FIG. 3A illustrates an example hailing-response protocol according to an implementation of the invention;

FIG. 3B illustrates an example multi-hop hailing-response protocol according to an implementation of the invention;

FIG. 4A is a map illustrating an example communication range for a road-side device according to an implementation of the invention;

FIG. 4B is a block diagram illustrating an example display interface for displaying the status of a transportation reservation request according to an implementation of the invention;

FIG. 5 illustrates the example hailing-response protocol of FIG. 3A;

FIG. 6A is a map illustrating an example location for a decentralized DSRC-based transportation request system;

FIG. 6B is a chart illustrating taxi availability in a transmission range and a waiving range during a simulation of the decentralized DSRC-based transportation request system of FIG. 6A;

FIG. 6C is a graph illustrating cruise time for taxis; and

FIG. 7 is a chart comparing the decentralized DSRC-based transportation request system to other transportation request systems.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for reserving transportation using a decentralized reservation system, it will become evident to those skilled in the art that the implementations are not limited thereto.

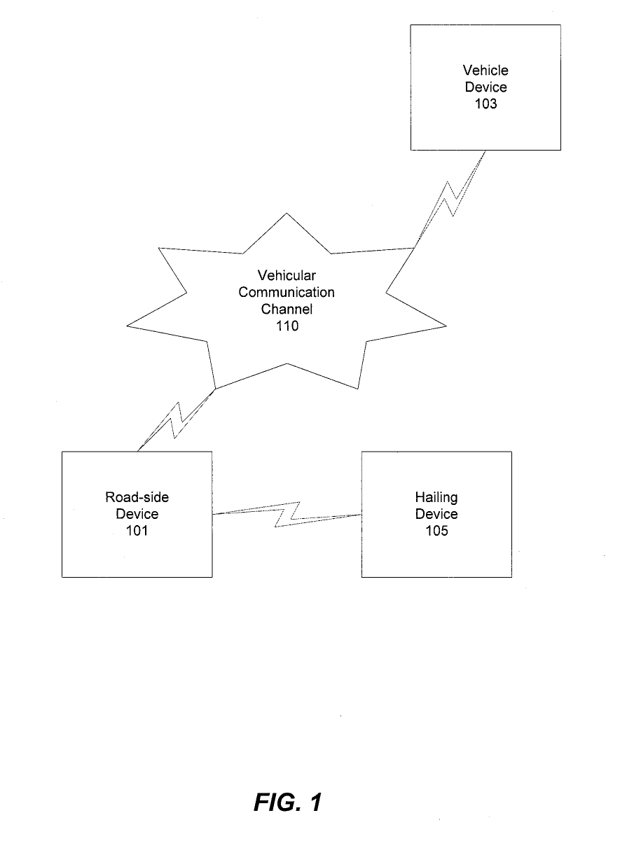

Referring now to FIG. 1, a block diagram illustrating a decentralized system for reserving transportation is shown. The decentralized system can include a road-side device 101, a vehicle device 103, a hailing device 105 and a vehicular communication channel 110. The decentralized system provides a distributed, self-organized and real-time system for reserving transportation such as allowing a passenger to hail a taxi, for example. The system is decentralized because it does not require interaction with a central dispatcher (i.e., a human operator) or a central server. It should be understood that the system may include more or less devices than are shown in FIG. 1, and that FIG. 1 is only one example configuration of a decentralized system.

As shown in FIG. 1, the road-side device 101 is communicatively connected to the vehicle device 103 through the vehicular communication channel 110. The vehicular communication channel 110 can provide a short to medium range wireless communication link between the road-side device 101 and the vehicle device 103. Optionally, the vehicular communication channel 110 can be reserved for use in vehicular environments. For example, the vehicular communication channel can facilitate vehicle-to-vehicle (V2V) and vehicle-to-infrastructure (V2I) communications. In an example implementation, the vehicular communication channel 110 can be a Dedicated Short Range Communication (DSRC) channel. DSRC is a technology specifically designed for vehicular use in order to provide a platform for wireless access in vehicular environments (WAVE). DSRC contributes to the Intelligent Transportation System (ITS). In the United States, the Federal Communications Commission (FCC) has provided a license for 7 channels spanning a total of 75 MHz spectrum in the 5.9 GHz band for the ITS. In Europe, the European Telecommunications Standards Institute (ETSI) has allocated 30 MHz of spectrum in the 5.9 GHz band for the ITS. DSRC is described in detail IEEE 802.11p, an amendment to the IEEE 802.11 standard, and incorporates both V2V and V2I communications. The implementations discussed herein should not be limited to the 5.9 GHz band currently reserved for DSRC. This disclosure contemplates that the transportation reservation request system can be implemented at any frequency band reserved for DSRC.

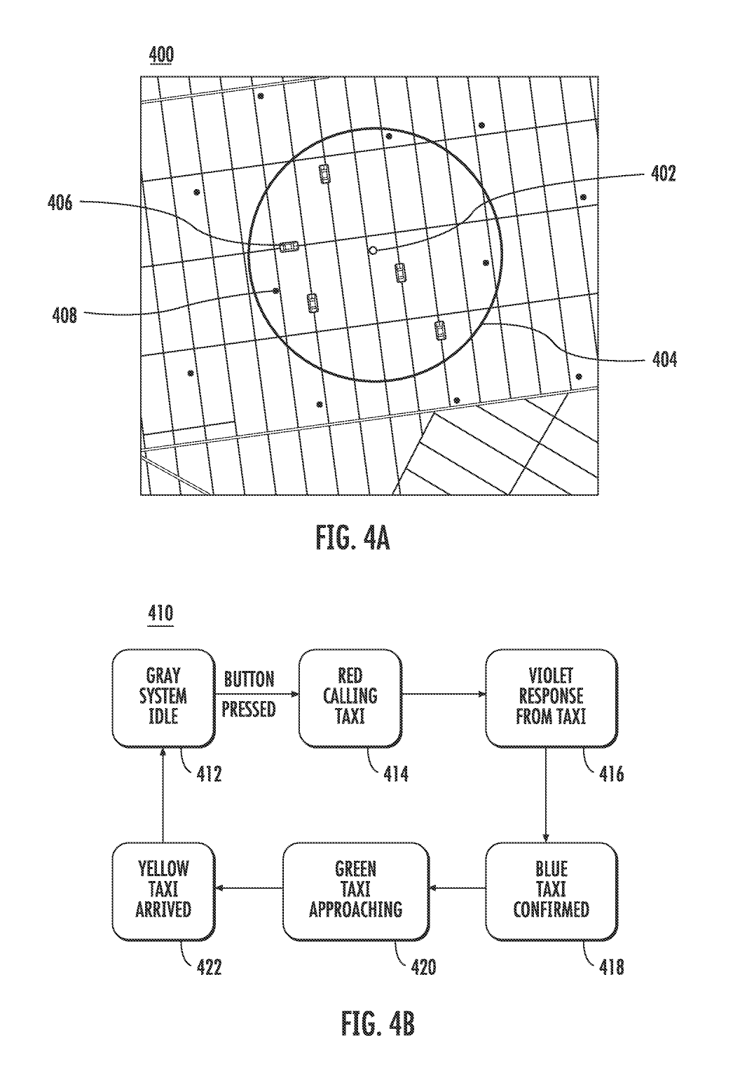

Referring to FIG. 4A, a map 400 illustrating an example communication range for a road-side device is shown. The road-side device may be at location 402, for example. The transmission range 404 of a DSRC signal is typically in the range between 300 and 1000 m, depending on the environment. For example, in a downtown area, the transmission range can be limited to less than 300 m due to buildings and other obstacles. In contrast, in sub-urban residential areas or rural areas the transmission range can be as large as 1000 m, which is the maximum range for DSRC signals. In addition, the vehicles having the vehicle devices 103 are at location(s) 406, and additional road-side devices are at location(s) 408, for example. There are a number of solutions for increasing the transmission range of DSRC signals, such as increasing transmission power and/or using a multi-hop system. In a multi-hop system, the additional road-side devices at location(s) 408 can relay transportation reservation requests beyond the maximum transmission range of the road-side device at location 402. A multi-hop hailing-request protocol is discussed in detail below. It may be desirable, for example, to increase the transmission range in order to broadcast the transportation reservation request to more vehicles (i.e., vehicles outside of the transmission range of the road-side device at location 402). Factors such as vehicle availability, vehicle demand, road system traffic, etc. may be considered before increasing the maximum transmission range.

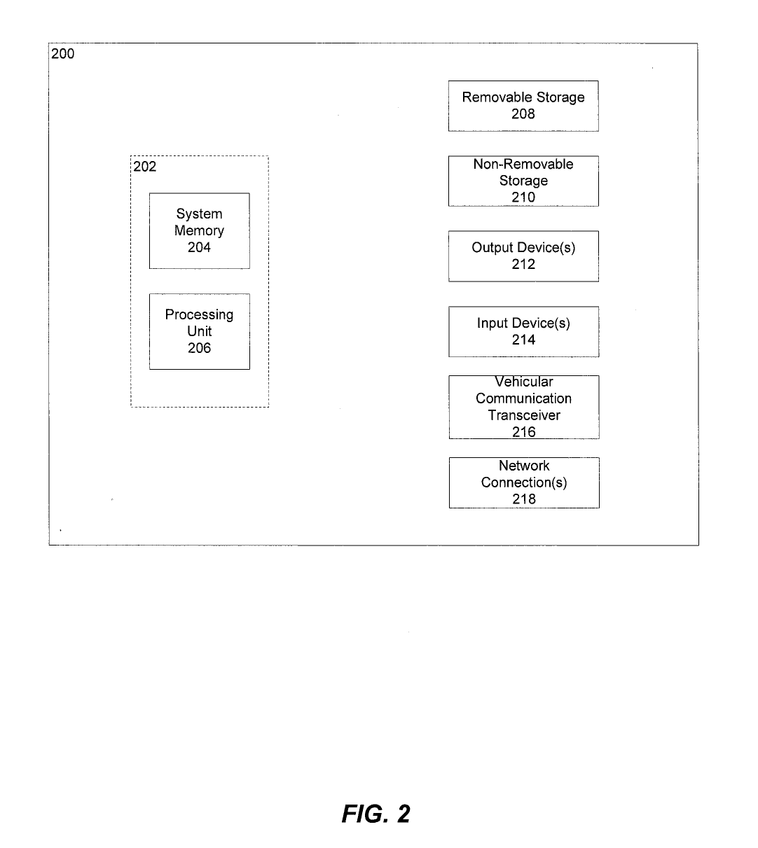

The road-side device 101 can be implemented as the example communication device 200 discussed below with regard to FIG. 2. The road-side device can be configured to communicate with the vehicle device 103 using the vehicular communication channel 110. For example, the road-side device 101 can include a transceiver, such as a DSRC wireless transceiver, for example, for communicating over the vehicular communication channel 110. The road-side device 101 may be a part of the DSRC infrastructure deployed by the U.S. Department of Transportation, for example. In addition, the road-side device 101 can include hardware and/or software for supporting wireless communication with the hailing device 105. As shown in FIG. 1, the road-side device 101 and the hailing device 105 may be communicatively connected. This connection can be a wireless communication link, such as Wi-Fi, Bluetooth, 3G, 4G, etc.

The hailing device 105 can be implemented as the example communication device 200 discussed below with regard to FIG. 2. The hailing device 105 can be used to initiate a transportation reservation request, such as hailing a taxi. In some implementations, the hailing device 105 can be a mobile computing device such as a smart phone, a PDA, a tablet computer, etc. For example, the mobile computing device may host or run an application program for reserving transportation. In addition, the mobile computing device can communicate with the road-side device 101 using the wireless communication link, such as Wi-Fi, Bluetooth, 3G, 4G, etc. Accordingly, the application program can provide a mechanism for making the transportation reservation request through the road-side device 101. In addition, the mobile computing device can specify the current location as the pickup location, for example, when the mobile computing device includes a GPS receiver. Alternatively, the pickup location can be the location of the road-side device 101 by default when the mobile computing device does not include a GPS receiver.

In another implementation, the hailing device 105 can be a mobile computing device that is configured to communicate with the vehicle device 103 using the vehicular communication channel 110 (FIG. 1). In this implementation, the hailing device 105 can communicate directly the vehicle device 103 instead of communicating with the vehicle device 103 through the road-side device 101. For example, the mobile computing device can include a transceiver, such as a DSRC wireless transceiver, for example, for communicating over the vehicular communication channel 110. The transceiver can be either an add-on transceiver that is detachably connected to the mobile computing device or a built-in transceiver that is installed when manufacturing the mobile computing device. It should be understood that when the hailing device 105 is configured to communicate directly with the vehicle device 103, the hailing device 105 can be configured to execute all of the operations discussed below performed by the road-side device 101.

In yet another implementation, the hailing device 105 can be a road-side hailing device. For example, the road-side hailing device may be installed along a portion of a city street. Similarly to the mobile computing device, the road-side hailing device may host or run an application program for reserving transportation. In addition, the road-side hailing device can communicate with the road-side device 101 using any wired or wireless communication link, i.e., the wireless communication link, such as Wi-Fi, Bluetooth, 3G, 4G, etc. Accordingly, the application program can provide a mechanism for making the transportation reservation request through the road-side device 101.

The road-side hailing device can include an operator interface (i.e., a switch, button, touch screen, etc.) for initiating a request for transportation, a display interface (i.e., a collection of LEDs) for displaying the status of the transportation reservation request, a digital counter to facilitate handling of a plurality of concurrent requests for transportation, and a display device for displaying information regarding the transportation reservation (i.e., a vehicle identifier and/or vehicle description and an estimated time of arrival at the pickup location).

Referring to FIG. 4B, an example display interface 410 for displaying the status of a transportation reservation request is shown. For example, when the system is idle (i.e., no pending transportation reservation requests), a grey LED 412 can be illuminated. After a transportation reservation request is made, a red LED 414 can be illuminated indicating that a service request is being broadcast (i.e., by the road-side device 101) to all vehicles within the transmission range of the road-side device 101. Once the service request is broadcast, all available vehicles within range of the road-side device 101 receive the service request (i.e., through the vehicle device 103) including the pickup location. If the vehicle is able to respond to the service request, the service request can be acknowledged using the vehicle device 103. After receiving acknowledgement to the service request, a violet LED 416 can be illuminated indicating that the service request has been acknowledged. In addition, a blue LED 418 can be illuminated indicating that a vehicle has confirmed the service request and is driving toward the pickup location. Optionally, the vehicle identifier and/or vehicle description and estimated time of arrival can be displayed on the display device. A green LED 420 can be illuminated indicating that the vehicle is approaching the pickup location, for example, when the vehicle parks near the pickup location. Then, a yellow LED 422 can be illuminated indicating that the vehicle has been reserved (i.e., the taxi is hired).

In addition, the hailing device 105 can be configured to handle a plurality of transportation reservation requests concurrently. For example, at certain times, there may be several passengers in queue waiting to initiate transportation reservation requests, particularly during the rush hours. Accordingly, the hailing device 105 can be configured to utilize a counter to process a plurality of service requests concurrently (i.e., in parallel) instead of having to service each service request serially. In some implementations, each new service request is assigned with a unique service request identifier, and all communications sent from and/or received by the road-side device 101 can be identified by the same unique identifier.

The vehicle device 103 can be implemented as the example communication device 200 discussed below with regard to FIG. 2. Vehicles, such as taxi cabs, can be equipped with the vehicle device 103, and therefore, the vehicles can be configured to communicate using the vehicular communication channel 110. For example, the vehicle device 103 may host or run an application program for reserving transportation. When a service request sent from the road-side device 101 is received, the vehicle device 103 can display message along with the pickup location. Upon receiving the service request, the vehicle device 103 can present two options: Accept or Reject. If the vehicle driver is not willing to accept the service request, the service request can be rejected using an operator interface on the vehicle device, such as a switch, button, touch screen, etc. The user interface can be designed to require minimal input from the vehicle driver in order to prevent distracting the vehicle driver's concentration. Optionally, a default response (i.e., Reject) may be set upon expiration of a predetermined period of time. If the vehicle driver is willing to accept the service request, the service request can be accepted using the operator interface. Optionally, the vehicle device may include a GPS module configured to calculate the estimated arrival time of arrival at the pickup location. This information can optionally be included in the acknowledgement to the service request. Additionally, the acknowledgment to the service request can include a vehicle identifier and/or vehicle description, which can be displayed on the display device of the hailing device 105, for example.

Referring to FIG. 2, an example communication device upon which embodiments of the invention may be implemented is illustrated. In particular, the road-side device 101, the vehicle device 103 and/or the hailing device 105 discussed above may be a communication device, such as communication device 200 shown in FIG. 2. The communication device 200 may include a bus or other communication mechanism for communicating information among various components of the communication device 200. In its most basic configuration, communication device 200 typically includes at least one processing unit 206 and system memory 204. Depending on the exact configuration and type of communication device, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the communication device 200.

In addition, the communication device 200 can optionally include a vehicular communication transceiver 216. For example, as discussed above, the road-side device 101 and the vehicle device 103 are communicatively connected through the vehicular communication channel 110, and therefore may include the vehicular communication transceiver 216. In some implementations, the hailing device 105 can include the vehicular communication transceiver 216 (i.e., when the hailing device 105 is configured to communicate directly with the vehicle device 103, such as when the hailing device is the mobile computing device). In other implementations, the hailing device 105 may not include the vehicular communication transceiver 216 (i.e., when the hailing device 105 is configured to communicate with the road-side device 101, such as when the hailing device is a road-side hailing device). The vehicular communication transceiver 216 is configured to communicate using the vehicular communication channel 110 discussed above. For example, the vehicular communication transceiver 216 can be a DSRC transceiver.

Communication device 200 may have additional features/functionality. For example, communication device 200 may include additional storage such as removable storage 208 and non-removable storage 210 including, but not limited to, magnetic or optical disks or tapes. Communication device 200 may also contain network connection(s) 218 that allow the device to communicate with other devices. In addition, in some implementations, the communications device 200 may be configured to communicate with other devices through a wireless communications link, such as Wi-Fi, Bluetooth, etc. Communication device 200 may also have input device(s) 214 such as a keyboard, mouse, touch screen, etc. Output device(s) 214 such as a display device and/or unit, speakers, printer, etc. may also be included. Additionally, communication device 200 may include a GPS receiver. The additional devices may be connected to the bus in order to facilitate communication of data among the components of the communication device 200. All these devices are well known in the art and need not be discussed at length here.

The processing unit 206 may be configured to execute program code encoded in tangible, computer-readable media. Computer-readable media refers to any media that is capable of providing data that causes the communication device 200 (i.e., a machine) to operate in a particular fashion. Various computer-readable media may be utilized to provide instructions to the processing unit 206 for execution. Common forms of computer-readable media include, for example, magnetic media, optical media, physical media, memory chips or cartridges, a carrier wave, or any other medium from which a computer can read. Example tangible, computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

Communication device 200 typically includes a variety of computer-readable media. Computer-readable media can be any available media that can be accessed by communication device 200 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 204, removable storage 208, and non-removable storage 210 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by communication device 200. Any such computer storage media may be part of communication device 200.

It should be appreciated that the logical operations described herein with respect to the various figures may be implemented (1) as a sequence of computer implemented acts or program modules (i.e., software) running on a communication device, (2) as interconnected machine logic circuits or circuit modules (i.e., hardware) within the communication device and/or (3) a combination of software and hardware of the communication device. Thus, the logical operations discussed herein are not limited to any specific combination of hardware and software. The implementation is a matter of choice dependent on the performance and other requirements of the communication device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

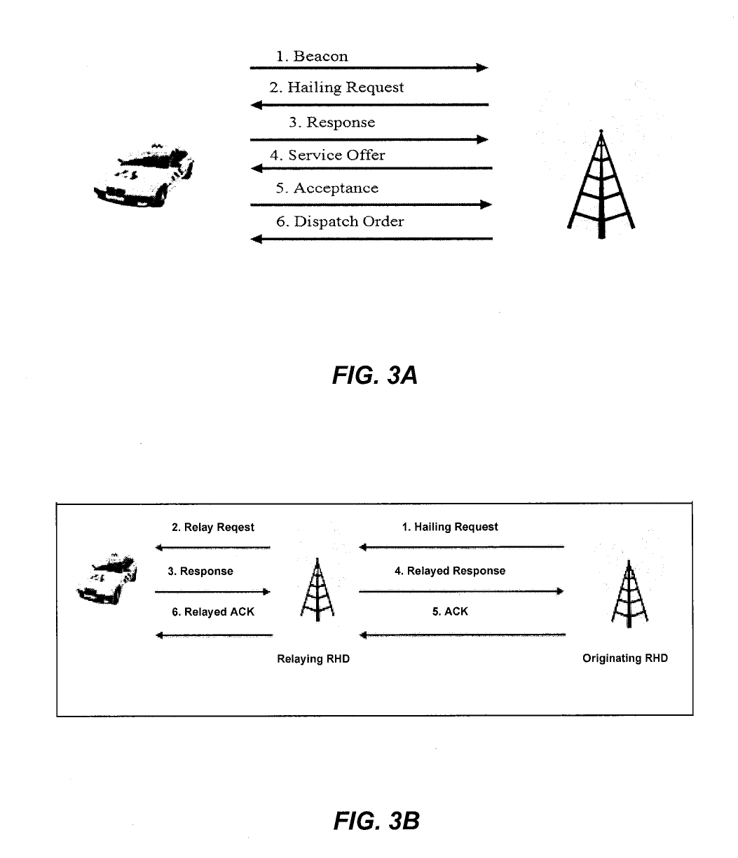

Referring now to FIG. 3A, a hailing-response protocol according to an implementation of the invention is shown. The hailing-response protocol can optionally include a beacon, a hailing request (i.e., a service request), a response (i.e., an acknowledgement to the service request), a service offer, an acceptance (i.e., an acknowledgement to the service offer) and a dispatch order (i.e., a dispatch message). Each of the messages in the hailing-response protocol is discussed in detail below. In addition, all of the messages in the hailing-response protocol can be transmitted using the vehicular communication channel 110, for example, according to the standards of IEEE 802.11p or WAVE when the vehicular communication channel 110 is a DSRC channel.

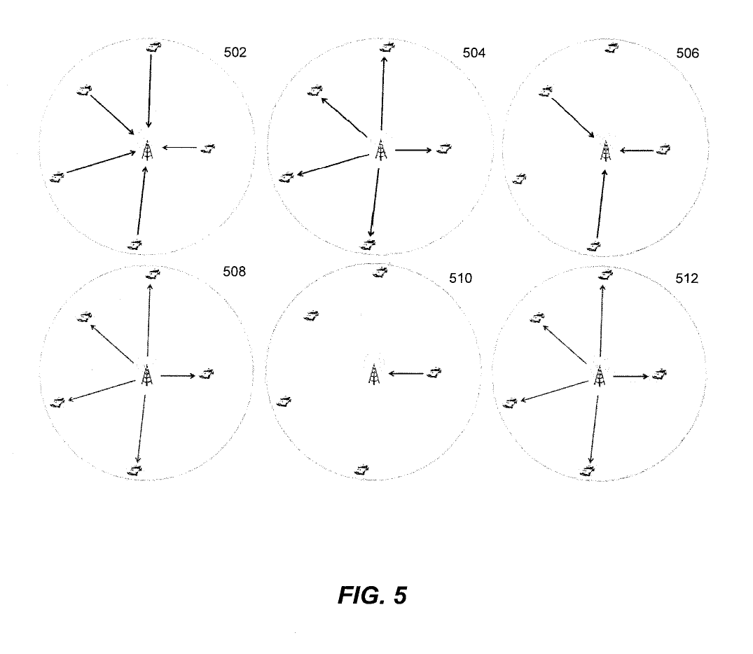

The beacon is a message that is periodically transmitted over the vehicular communication channel 110 from the vehicle device 103 that notifies other vehicle devices and/or road-side devices of the vehicle device's current location. Transmission of the beacon is illustrated in FIG. 5 in the message flows illustrated in 502. For example, the beacon can be an extended version of the “Here I am” message defined by the SAE J2735 standard for DSRC message set dictionary according to IEEE 802.11p. The beacon is sometimes referred as the vehicle's “heartbeat” and is generally broadcast on a periodic basis to inform all other DSRC enabled vehicles as well as road side devices about the current location of the vehicle. The current location of the vehicle can be a GPS coordinate received by the GPS receiver included in the vehicle device, for example. In addition to the location information, the beacon can optionally include an occupancy status of the vehicle (i.e., occupied or unoccupied by a passenger) and a timestamp. For example, the beacon can include the following fields: a) GPS Location: Two floating point values indicating Latitude and Longitude of the vehicle; b) Occupancy Status: Binary value (0 or 1) indicating whether the vehicle is currently occupied or not; and c) Timestamp: Unix timestamp of sending the beacon.

The service request (or hailing request) is a message initiated by a user (i.e., a passenger) requesting a transportation reservation. As discussed above, the service request can be initiated using the hailing device 105, for example. The service request can then be transmitted over the vehicular communication channel 110. In some implementations, the service request can be transmitted directly from the hailing device 105 to the vehicle device 103, while in other implementations, the service request may be sent through the road-side device 101. The service request may include the following fields: a) a unique service request identifier (Req_ID) that identifies the service request (i.e., to facilitate handling of a plurality of concurrent service requests); b) a relay request (Relay_req) that specifies a request for multi-hop forwarding; c) a road-side device identifier (RHD_ID) that identifies the originating road-side device and a pickup location; d) a request status (Req_Status) that specifies whether the request is active or complete/cancelled (for example, a 1-bit field where 1=Active and 0=Complete/Cancelled); and e) a timestamp that specifies the time that the service request is generated. As shown in FIG. 5, the service request can be transmitted from a road-side device (or alternatively a hailing device) and received by a plurality of vehicle devices within the transmission range of the road-side device, as shown in the message flows illustrated in 504.

In some implementations, the vehicle device 103 can be configured to filter the incoming service requests. For example, the vehicle device 103 can be configured to filter the service requests based on the vehicle's occupancy status. If the vehicle is currently occupied by a passenger, the vehicle device 103 can be configured to drop the service request (i.e., not display the service request to the driver of the vehicle to minimize driver distraction). On the other hand, if the vehicle is currently unoccupied by a passenger, the vehicle device 103 can be configured to display the service request, for example, on the display device of the vehicle device 103.

After receiving the service request, the service request can be acknowledged in a response by the driver(s) of the vehicle(s) using, for example, an operator interface of the vehicle device 103. The vehicle device 103 can be configured to present the vehicle driver with two options: Accept or Reject. As shown in FIG. 5, some of the vehicles receiving the service request have acknowledged the service request, as shown in the message flows illustrated in 506. The acknowledgement to the service request can be transmitted over the vehicular communication channel 110 to the road-side device 101. In addition, if the driver of the vehicle fails to acknowledge the service request within a predetermined period of time, the vehicle device can be configured to reject the service request by default. The acknowledgment to the service request may include the following fields: a) the unique service request identifier (Req_ID) that identifies the corresponding service request; b) Accept/Reject that specifies whether the request is accepted or not (for example, a 1-bit field where Accept=1 and Reject=0); c) a vehicle identifier (VRD_ID) that identifies the responding vehicle's vehicle device; d) a vehicle description that indicates the vehicle, such as an alphanumeric taxi number, for example; and e) an estimated time of arrival at the pickup location.

The acknowledgment to the service request may then be received by the road-side device 101. It should be understood that the road-side device 101 may receive a plurality of acknowledgments from a plurality of vehicle devices (i.e., when multiple drivers accept the service request). In this case, the road-side device 101 can be configured to select a vehicle among the plurality of vehicles that acknowledged the service request by making a service offer. The road-side device 101 may be configured to select the first vehicle in time to acknowledge the service request, the vehicle nearest to the road-side device 101, or any other mechanism for selecting a vehicle. After receiving the acknowledgement to the service request (and optionally selecting a vehicle), a service offer can be transmitted over the vehicular communication channel 110 from the road-side device 101 to the vehicles. The service offer may be audible to any vehicle device within the transmission range of the road-side device 101 but addressed only to the selected vehicle. The service offer is shown in FIG. 5 in 508. The service offer may include the following fields: a) the unique service request identifier (Req_ID) that identifies the corresponding service request; b) the relay request (Relay_req) that specifies a request for multi-hop forwarding; c) a confirmation that specifies whether the positive response (i.e., acceptance) is confirmed or not (for example, a 1-bit field where 1=Confirmed and 0=Denied); and d) the vehicle identifier (VRD_ID) that identifies the selected vehicle's vehicle device.

Upon receipt of the service offer, the service offer can be acknowledged using the vehicle device 103 of the selected vehicle in an acceptance. As shown in FIG. 5, the acknowledgement to the service offer can be transmitted over the vehicular communication channel 110 from the vehicle device 103 to the road-side device 101, as illustrated in the message flows shown in 510. At this time, information regarding the vehicle such as the vehicle identifier and/or vehicle description and the estimated time of arrival at the pickup location can be displayed, for example, using the display device of the hailing device 105.

After receiving the acknowledgment to the service offer, a dispatch order in a dispatch message can be transmitted over the vehicular communication channel 110 from the road-side device 101 to the vehicles. The dispatch message is show in FIG. 5 in 512. The dispatch message notifies all of the other vehicles within the transmission range of the road-side device 101 that the service request has been satisfied and cancels the outstanding service offer. Accordingly, the dispatch message may include the following fields: a) the unique service request identifier (Req_ID) that identifies the corresponding service request; b) a relay request (Relay_req) that specifies a request for multi-hop forwarding; and c) a request status (Req_Status) that specifies whether the request is active or complete/cancelled (for example, a 1-bit field where 1=Active and 0=Complete/Cancelled); and d) the vehicle identifier (VRD_ID) that identifies the responding vehicle's vehicle device.

Referring now to FIG. 3B, an example multi-hop hailing-response protocol according to an implementation of the invention is shown. The multi-hop hailing-response protocol can be used to increase the transmission range beyond the transmission range of the road-side device 101, for example. In particular, in a multi-hop environment, the messages in the protocol are relayed by other road-side devices and/or vehicle devices in order to increase the transmission range. The multi-hop hailing-response protocol can be enable using the relay request field (Relay req) in the messages transmitted by the road-side device 101. Because the messages transmitted in the multi-hop hailing-response protocol are identical to the messages transmitted in the hailing-response protocol discussed with regard to FIG. 3A, the messages are not discussed in detail below.

In order to increase the availability of vehicles in rural or sub-urban areas, or even in urban areas where the vacancy ratio is low, the multi-hop hailing-response protocol can extend signaling over multiple hops. Even though there is no limitation on the maximum number of hops the signals can span, in practical implementation, multi-hop forwarding can be limited to 5 hops, which corresponds to a geographical distance of less than 5 km in rural areas. It may not be desirable to request a vehicle, such as a taxi, to pick up a passenger driving more than 5 km away from the vehicle's current location. This kind of remote hailing request can be made through advanced reservation or booking, for example.

FIG. 3B shows an example of multi-hop forwarding over two hops. For example, the road-side device transmits a service request with a new Req_ID and the Relay_req set to 0 (i.e., requesting non-multi-hop forwarding). The service request is transmitted over the vehicular communication channel 110, for example, to the vehicles. In some implementations, if no acknowledgement is received by the road-side device after expiration of a predetermined period of time, such as 10 seconds, for example, the road-side device can re-send the service request with the same Req_ID and the Relay_req set to 1 (i.e., requesting multi-hop forwarding). The service request is again transmitted over the vehicular communication channel 110, for example, to the vehicles. However, because the Relay_req is set for multi-hop forwarding, the service request can be broadcast (i.e., relayed) by other road-side devices and/or vehicle devices. The broadcast service request can be transmitted (with standard treatments of handling wireless broadcast, such as, broadcast jitter, message suppression, etc.) to respective zones. If any available vehicle within the range of the relaying device acknowledges the service request, the acknowledgement is transmitted back to the originating road-side device using multi-hop forwarding. It should be understood that the other messages in the hailing-response protocol (i.e., the service offer, acknowledgement of the service offer, dispatch message, etc.) can be handled similarly. It should also be understood that the example predetermined period of time (i.e., 10 seconds) and Relay_req (i.e., 1-bit field) are only examples and can be other values.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a communication device, the machine becomes an apparatus for practicing the presently disclosed subject matter. In the case of program code execution on programmable computers, the communication device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

A. Simulation Environment

To evaluate the performance and effectiveness of a decentralized transportation reservation system, a decentralized DSCR-based system was simulated using real world mobility traces from San Francisco Yellow Cabs. The mobility traces collected data during one month from the central server of the taxi company. These trace records were organized in individual ascii files for each of the 536 licensed taxis. Mobility traces from each of the taxis are received by the server every minute through the satellite. Each trace contains the following records: 1) Latitude & Longitude: Two floating point values of the current GPS position of the taxi; 2) Occupancy status: A binary value indicating the passenger occupancy status where a value of 0 indicates that the taxi is free while the value of 1 indicates that the taxi was hired by passenger; and 3) Timestamp: Unix or epoch timestamp of the trace reception time.

The trace files were simulated using a developed application. Some useful information regarding taxi usage and trip patterns were analyzed first. This information can be useful for practical deployment of the decentralized system, for example, by knowing the hotspots for taxi pickup and drop off. To analyze the effectiveness of the decentralized system, the increase of taxi availability was measured and compared to the usual street hailing process (i.e., hand waiving). In addition, the hit ratio in both the San Francisco downtown and nearby residential areas was calculated.

B. Increased Availability and Reduced Waiting Time

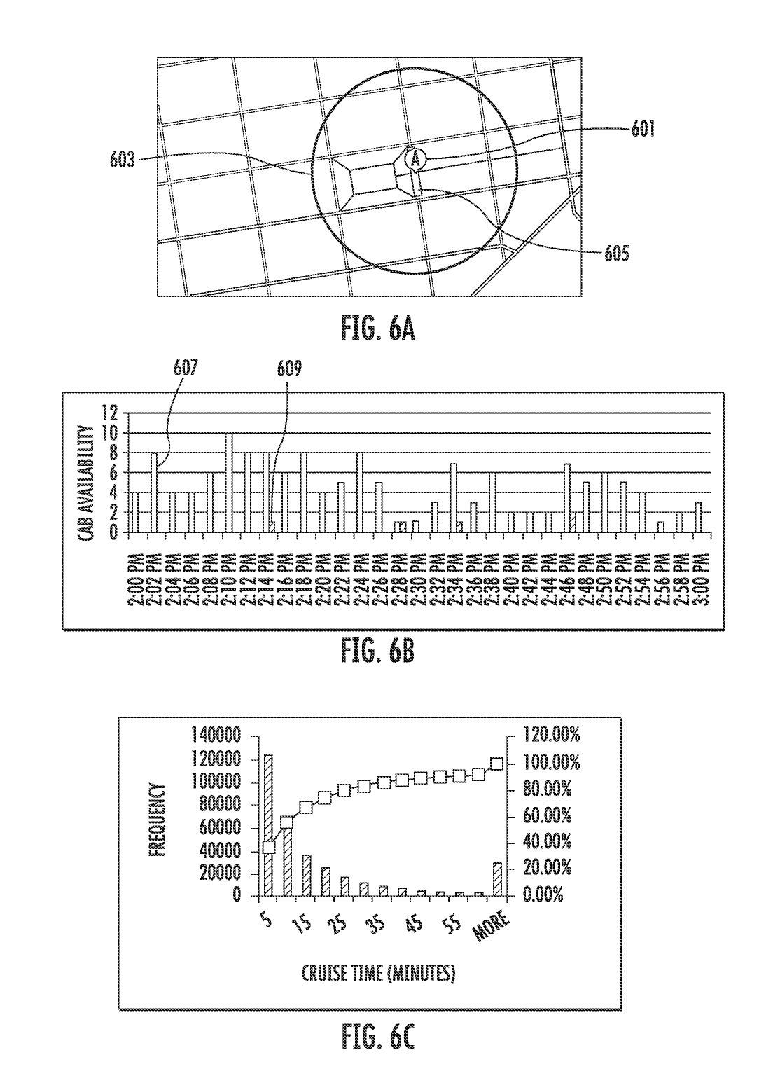

In order to see the effect of deploying the decentralized DSRC-based transportation reservation system, an experimental time span of one hour in the afternoon (i.e., 2 pm to 3 pm) on a random working day (i.e., Monday, Jun. 2, 2008) near the heart of San Francisco downtown was chosen. Because there is less demand for taxis in the downtown on weekends and holidays, and to more accurately measure the demand and availability, a working day was chosen. The GPS location of the experimental pickup spot 601 is (37.788031,−122.406691), which is shown in FIG. 6A. Assuming that there is a road-side hailing device (i.e., a hailing device and/or a road-side device) installed at a light post near the experimental pickup spot, and considering a short transmission range of 300 meter for the downtown area, the transmission region 603 shown in FIG. 6A defines the coverage area of the road-side device where any free taxi can respond to a hailing request within this region. On other hand, without the hailing device, a passenger may only be capable of securing the attention of a taxi driver by waving hands within the road segment where he is standing. The waiving region 605 is shown in FIG. 6A.

Referring now to FIG. 6B, the taxi availability for both the regions (i.e., the transmission region and the waiving region) within the time frame of 2 pm to 3 pm is shown. The bars 607 indicate the number of free taxis available within the transmission region, and the bars 609 indicate the number of free taxis passing through the road segment marked as the waiving region. FIG. 6B shows that a total of 150 taxis were available within the one hour duration if the road-side hailing device was deployed. On the other hand, only 5 taxis passed through the road segment marked as the waiving region. Moreover, a passenger seeking a taxi at 2 pm would have to wait till 2:14 pm to see the first available taxi passing in front of him. Whereas, if the road-side hailing device ice was deployed, the passenger would, in the worst case, wait for 1-2 minutes for any taxi to pick him up coming from less than 300 meters away. Hence, the decentralized DSRC-based transportation reservation system not only increases the availability of taxis, but also reduces waiting time.

C. Average Hit Size

Considering the average hit size over the whole month at the previously mentioned downtown location, the simulation showed that, at any particular moment between 6 AM to midnight, the average number of available taxis to respond to a service request sent from road-side hailing device is 4.01. This means at least 4 passengers could be served every minute from a single road-side hailing device. This equals to a total serving capacity of 4,330 trips from the road-side hailing device within the specified 18 hour time frame. It must be noted that these statistics apply to the city of San Francisco where the total number of taxis is 536. In a city like New York, where 13,000 taxis make an average of 470,000 daily trips, the average hit size would be much higher than that of San Francisco.

In sub-urban areas, the hit size is comparatively low as passengers mostly travel with their own cars. Nevertheless, a sample location (37.7573, −122.491363), which is near the San Francisco Bay area gives an average hit size of 0.18 per minute or 194 per day.

According to the NYC Taxi Cab Fact book, cruise time is another important metric that represents the availability of taxi. Cruise time is defined as the interval between a passenger drop off and subsequent pickup. During this period, the driver cruises around in search of another passenger. If the total demand for taxi is fixed, then the longer cruise times correspond to times of higher availability. FIG. 6C shows the histogram with cumulative frequency distribution of cruise time over the month. FIG. 6C shows that about half of the time, the drivers have to wait for at least 10 minutes to pick up the next passenger. If the decentralized DSRC-based transportation request system is deployed, it can reduce unnecessary cruise time by increasing the demand and availability of taxis.

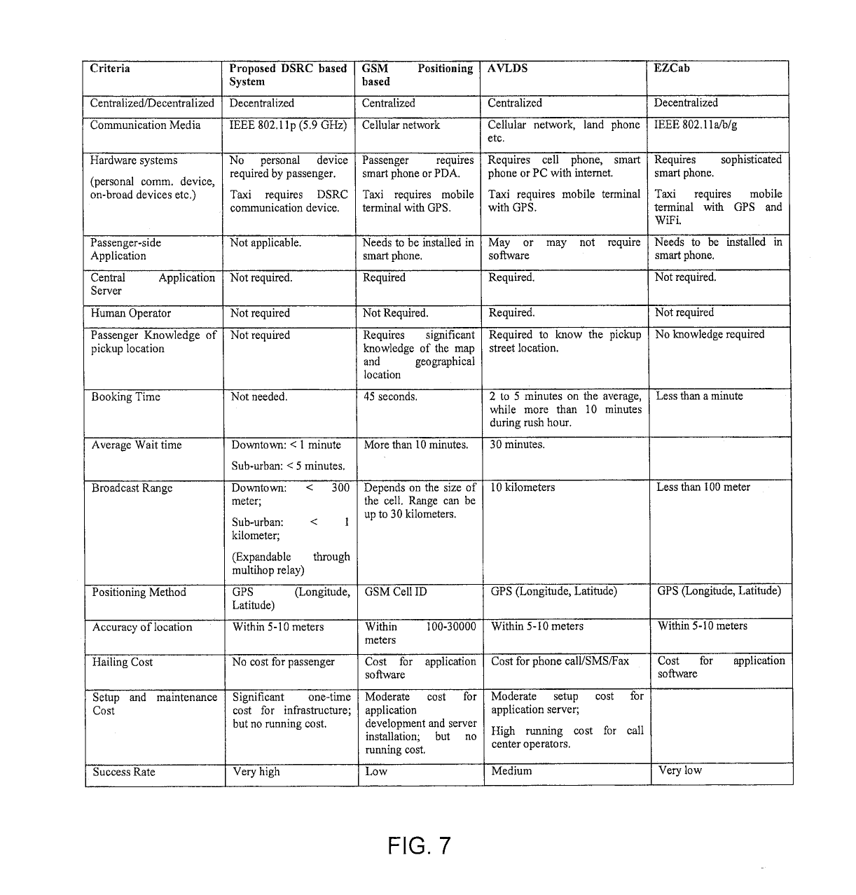

Based on the simulation results, decentralized DSRC-based transportation request system proves to be the fastest with highest success rate compared to other existing automated taxi dispatching systems. FIG. 7 shows a comparative analysis between the decentralized DSRC-based transportation request system and other transportation request systems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for reserving transportation, comprising:
sending a service request over a vehicular communication channel to at least one vehicle, the service request comprising a pickup location; and
receiving an acknowledgment to the service request over the vehicular communication channel from at least one vehicle.

2. The method of claim 1, wherein a range of the service request and the acknowledgment to the service request is less than approximately 1 km.

3. The method of claim 1, wherein the vehicular communication channel operates at approximately 5.9 GHz.

4. The method of claim 1, wherein the vehicular communication channel is a dedicated short range communication (DSRC) channel.

5. The method of claim 1, wherein the service request is sent directly from a mobile computing device to the at least one vehicle, the acknowledgment to the service request is received at the mobile computing device directly from the at least one vehicle, and the pickup location is a location of the mobile computing device.

6. The method of claim 1, wherein the service request is sent through a road-side device to the at least one vehicle, the acknowledgment to the service request is received through the road-side device from the at least one vehicle, and the pickup location is a location of the road-side device.

7. The method of claim 1, further comprising:
receiving acknowledgments to the service request over the vehicular communication channel from a plurality of vehicles;
selecting a vehicle among the plurality of vehicles that acknowledged the service request;
sending a service offer to the selected vehicle over the vehicular communication channel; and
receiving an acknowledgment to the service offer over the vehicular communication channel from the selected vehicle, wherein the acknowledgment to the service offer identifies the selected vehicle and estimates a time of arrival at the pickup location.

8. The method of claim 7, further comprising sending a dispatch message over the vehicular communication channel to the plurality of vehicles, the dispatch message indicating that the service request has been fulfilled.

9. The method of claim 1, wherein the service request further comprises at least one of a service request unique identifier and a timestamp.

10. The method of claim 1, further comprising:
sending the service request over the vehicular communication channel to the at least one vehicle using a first device; and
after expiration of a predetermined period of time without receiving an acknowledgement to the service request, resending the service request over the vehicular communication channel to the at least one vehicle using the first device, wherein the re-sent service request further comprises a relay request that is configured to cause at least a second device geographically separated from the first device to broadcast the re-sent service request.

11. The method of claim 10, wherein the second device is at least one of a road-side device or a vehicle device.

12. A method for receiving and acknowledging a transportation reservation request from a vehicle, comprising:
receiving a service request over a vehicular communication channel, the service request comprising a pickup location; and
sending an acknowledgment to the service request over the vehicular communication channel.

13. The method of claim 12, wherein a range of the service request and the acknowledgment to the service request is less than approximately 1 km.

14. The method of claim 12, wherein the vehicular communication channel operates at approximately 5.9 GHz.

15. The method of claim 12, wherein the vehicular communication channel is a dedicated short range communication (DSRC) channel.

16. The method of claim 12, further comprising:
receiving a service offer over the vehicular communication channel; and
sending an acknowledgment to the service offer over the vehicular communication channel, wherein the acknowledgment to the service offer identifies the vehicle and estimates a time of arrival at the pickup location.

17. The method of claim 12, further comprising periodically sending a beacon message comprising at least one of a location of the vehicle, a passenger occupancy status and a timestamp.

18. The method of claim 17, further comprising:
filtering the service request using the passenger occupancy status;
passing the service request under the condition that the passenger occupancy status is unoccupied; and
dropping the service request under the condition that the passenger occupancy status is occupied.

19-28. (canceled)

29. A device for reserving transportation, comprising:
a processing unit;
a memory communicatively connected to the processing unit for storing computer-executable instructions that, when executed by the processing unit, cause the device to:
receive a service request;
send the service request over a vehicular communication channel to at least one vehicle, the service request comprising a pickup location; and
receive an acknowledgment to the service request over the vehicular communication channel from at least one vehicle; and
a display unit for displaying a status of the service request.

30. The device of claim 29, wherein the vehicular communication channel is a dedicated short range communication (DSRC) channel.

31. The device of claim 30, the device further comprising a DSRC transceiver for sending the service request and receiving the acknowledgement to the service request.

32. The device of claim 29, wherein the memory includes further computer-executable instructions stored thereon that, when executed by the processing unit, cause the device to:
receive acknowledgments to the service request over the vehicular communication channel from a plurality of vehicles;
select a vehicle among the plurality of vehicles that acknowledged the service request;
send a service offer to the selected vehicle over the vehicular communication channel;
receive an acknowledgment to the service offer over the vehicular communication channel from the selected vehicle, wherein the acknowledgment to the service offer identifies the selected vehicle and estimates a time of arrival at the pickup location; and
display the selected vehicle and the estimated time of arrival at the pickup location on the display unit.

33. The device of claim 32, wherein the memory includes further computer-executable instructions stored thereon that, when executed by the processing unit, cause the device to send a dispatch message over the vehicular communication channel to the plurality of vehicles, the dispatch message indicating that the service request has been fulfilled.

34. The device of claim 29, wherein the memory includes further computer-executable instructions stored thereon that, when executed by the processing unit, cause the device to:
send the service request over the vehicular communication channel to the at least one vehicle using a first device; and
after expiration of a predetermined period of time without receiving an acknowledgement to the service request, resend the service request over the vehicular communication channel to the at least one vehicle using the first device, wherein the re-sent service request further comprises a relay request that is configured to cause at least a second device geographically separated from the first device to broadcast the re-sent service request.

35. A vehicle device for receiving and acknowledging a transportation reservation request, comprising:
a processing unit;
a memory communicatively connected to the processing unit for storing computer-executable instructions that, when executed by the processing unit, cause the vehicle device to:
receive a service request over a vehicular communication channel, the service request comprising a pickup location; and
send an acknowledgment to the service request over the vehicular communication channel; and
a display unit for displaying a status of the service request.

36. The vehicle device of claim 35, wherein the vehicular communication channel is a dedicated short range communication (DSRC) channel.

37. The vehicle device of claim 35, wherein the memory includes further computer-executable instructions stored thereon that, when executed by the processing unit, cause the vehicle device to:
receive a service offer over the vehicular communication channel;
display the service offer on the display unit; and
send an acknowledgment to the service offer over the vehicular communication channel, wherein the acknowledgment to the service offer identifies the vehicle and estimates a time of arrival at the pickup location.

38. The vehicle device of claim 35, wherein the memory includes further computer-executable instructions stored thereon that, when executed by the processing unit, cause the vehicle device to periodically send a beacon message comprising at least one of a location of the vehicle, a passenger occupancy status and a timestamp.

39. The vehicle device of claim 38, wherein the memory includes further computer-executable instructions stored thereon that, when executed by the processing unit, cause the vehicle device to:
filter the service request using the passenger occupancy status;
display the service request on the display unit under the condition that the passenger occupancy status is unoccupied; and
drop the service request under the condition that the passenger occupancy status is occupied.
